(19) United States
(12) Patent Application Publication
(10) Pub. No.: US 2024/0310551 A1
(43) Pub. Date: Sep. 19, 2024

(54) APPARATUS AND METHOD FOR COMPENSATION OF FORMATION EVALUATION TOOLS

(71) Applicant: Cordax Evaluation Technologies Inc., Calgary (CA)

(72) Inventors: Daniel C. MINETTE, Waynesboro, VA (US); Curtis LENTZ, Calgary (CA)

(21) Appl. No.: 18/550,262

(22) PCT Filed: May 20, 2022
(86) PCT No.: PCT/CA2022/050816

§ 371 Date: Sep. 12, 2023

Related U.S. Application Data
(60) Provisional application No. 63/191,748, filed on May 21, 2021.

(51) Int. Cl. G01V 5/12; G01V 13/00

(52) U.S. Cl. CPC G01V 5/12; G01V 13/00

(57) ABSTRACT

An apparatus for compensated formation evaluation has an outer housing; an inner housing disposed within the outer housing; an emitter disposed within the inner housing; a first sensor disposed within the inner housing; a first window in the outer housing, positioned about the emitter, to permit signals from the emitter to pass out of the outer housing; a second window in the outer housing, positioned about the first sensor, to permit signals to reach the first sensor from out of the outer housing; a second sensor disposed within the inner housing.

### TECHNICAL FIELD

The present invention relates to formation evaluation apparatus and methods in general, and apparatus and method for compensation of formation evaluation tools in particular.

### BACKGROUND

The field of the invention is formation evaluation. There are a number of forms of formation evaluation, including wireline, MWD/LWD (Measurement While Drilling/Logging While Drilling), and LWT (Logging While Tripping).

There are numerous compensated tools in the oil and gas service industry. Two examples of the many tools are compensated density and multiple propagation resistivity tools. The compensation is generally for effects beyond but close to the tool. For compensated density tools, the compensation is for borehole fluid and mudcake. For resistivity tools, compensation is typically for effects of near zone with borehole fluid invasion.

Conventional compensated tools do not compensate for the variations within the outer tool housing. One example of this might be the mud flow tube in an MWD/LWD tool. Another would be the fluid between the inner and outer housings of a LWT tool. In both cases, there may be additional background interference signals, or “noise” that comes from inside the outer tool housing. This noise is often variable and large enough to provide significant errors in measurement of formation properties. Accordingly, there is a demand for apparatus and methods to compensate for noise occurring within the outer tool housing.

### SUMMARY OF INVENTION

In accordance with a broad aspect of the present invention, there is provided an apparatus for compensated formation evaluation, comprising: an outer housing; an inner housing disposed within the outer housing; an emitter disposed within the inner housing; a first sensor disposed within the inner housing; a first window in the outer housing, positioned about the emitter, to permit signals from the emitter to pass out of the outer housing; a second window in the outer housing, positioned about the first sensor, to permit signals to reach the first sensor from out of the outer housing; and a second sensor disposed within the inner housing.

In accordance with another broad aspect of the present invention, there is provided a method for configuring an apparatus for formation evaluation to compensate for noise, comprising: positioning a sensor in an inner housing of the apparatus within a shielded portion of an outer housing of the apparatus.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, as follows.

FIG. 1A is a cross sectional view of a density tool with two sensors according to one embodiment of the present invention.

FIG. 1B is a cross sectional view of a density tool with three sensors according to another embodiment of the present invention.

FIG. 2 is a partly cut-away, magnified view of two of the three sensors of FIG. 1B, namely, the mid-space and long-space sensors.

FIG. 3 is prior art, namely, FIG. 3 of U.S. Pat. No. 6,666,285 B2.

FIG. 4 is prior art, namely, FIGS. 2A and 2B of U.S. Pat. No. 5,184,692.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The methods and apparatus described herein can apply to numerous forms of oil well logging, with many of its application in MWD/LWD, and LWT. While gamma radiation and other types of signals are used herein as illustrative examples, it is to be appreciated that the present invention may be used for applications involving other or additional types of signals, waves or radiation, for example, sound waves, and other types of matter that give rise to noise, such as neutrons.

The purpose of this invention is to compensate for sources of error within the tool caused by variables that are not part of the tool design (typically the borehole fluid inside the outer diameter (OD) of the tool). In a compensated tool, there are usually two or more sensors that have varying dependence on the property of the external environment of the tool, allowing for the measurement of more than one formation property, and/or compensating for borehole properties. This invention adds one or more sensors that allow for the compensation for environmental effects within the tool itself (e.g., the borehole fluid between the inner and outer housing of a LWT tool.

This may be accomplished by having additional measurements that are more sensitive to the environmental effects within the tool than the original measurements and less affected by the external environment. This allows one to use the additional measurements to compensate for environmental effects within the tool.

Tools may be compensated density tools that have two sensors, with gamma-ray transmissive windows that face the formation. The windows may be annular. The basis for the measurement of density is usually the count rate for the sensor furthest from the source (the long spaced sensor). Density may be also calculated using the sensor closer to the source (the short spaced sensor). The difference between these two densities may be used to calculate a correction to the long spaced density, resulting in a compensated density.

In the case of logging while tripping (LWT), there may be another non-tool element that affects sensor count rate: the borehole fluid between the inner housing (which contains the sensor), and the outer housing (which is part of the drill string). This fluid can have a significant effect on the counts per second (cps) of the sensors, providing a variable background noise that is a significant fraction of the total cps, especially, for example, at higher densities.

In order to address this noise, a third sensor may be added, thereby providing a tool that has short spaced, mid spaced and long spaced sensors. The short and mid spaced sensors may be similar to the short and long spaced sensors seen in conventional tools (e.g. wireline or MWD tools). The new long spaced sensor may not have a gamma-ray transmissive window between it and the formation. Rather, the housing contains a high density (gamma ray shielding) material in the long spaced sensor region of the outer housing, which may be inherent in the outer housing's material. One embodiment of this is to keep a window in front of the tool and fill it with high density, high atomic number (Z) material(s), such as steel, lead or tungsten. Another would be to simply not cut a window in front of the long spaced sensor, allowing the shielding material of the outer housing to remain. The geometry of the shielding may be circumferential around the sensor.

Such an embodiment may provide a sensor that has a strong dependence on the density and photoelectric absorption (Pe) of the borehole fluid between the inner and outer housing, and a minimal dependence on the formation and on the fluid in the borehole, outside of the outer housing. Measurements made by the long spaced sensor can be used to calculate the variable background cps due to the fluid between the inner and outer housing for the short and medium spaced sensors. While there can be a small amount of background noise cps from gammas that reach the borehole fluid and mudcake beyond the outer housing and the formation for the long spaced sensor, there are numerous numeric and/or algorithmic techniques for correcting for this effect and the effect of the borehole fluid, and precipitates in the fluid between the inner and outer housings for the short spaced and medium spaced sensor. One such technique may be perturbation, which has been shown to be a quick and accurate means of obtaining the correct count rates.

The present apparatus and method may, in one embodiment, be used for correcting errors caused by outside sources of radiation. Gamma rays from formation and/or drilling mud may create background noise for the density tool. For example, in spectral gamma tools, there is often a surplus of gammas seen in channel 255, above the approximately 662 keV (kiloelectronvolt) cesium source peak. Multiple scatterings of these gamma rays emanating from the formation will result in lower energy gamma rays detected in the range below 662 keV, where count rates are recorded for density and Pe measurement. That number is typically relatively small enough to ignore since the relative activity of the source is much greater. So, unless there is a very high American Petroleum Institute units (API) bed (e.g. >1000 API), formation gammas are rarely a significant factor. However, potassium in the drilling mud as a gamma ray source is much closer to the sensor in a LWT tool. It is typically between the outer and inner housing, and can provide a much higher background of KCl gammas than seen with a wireline or MWD tool.

In addition, this fluid (as well as material rich in hydrogen) near the sensors can be the source of prompt neutron induced gamma rays. This is the case when a source of neutron radiation is present near the density tool, which is a common practice to include these tools together in a combined string.

Compensation for both types of noise (noise from gamma rays from formation and/or drilling mud, and noise from neutron induced gamma rays) is possible. The gamma rays induced by neutrons can be calculated from test pit measurements and/or modeling and measured while logging. The gamma rays from fluids can be both calculated by the same techniques and measured while logging. This will allow the subtraction of both types of background noise from the count rate seen at each short space and mid space sensor.

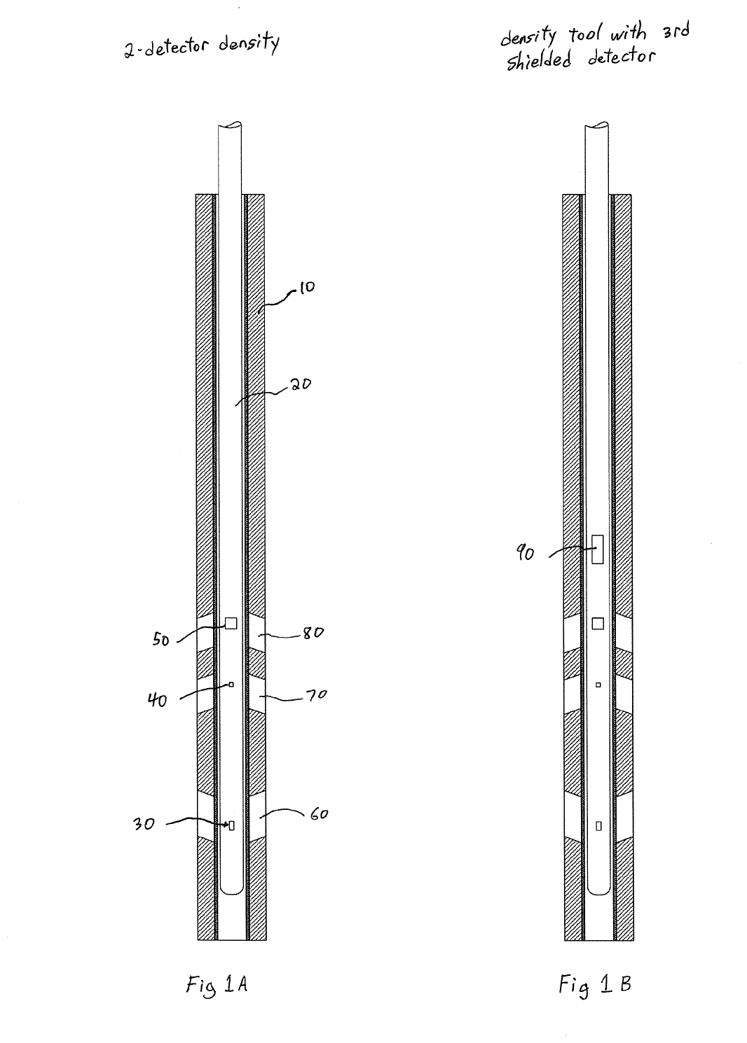

FIG. 1A illustrates a cross sectional view of a density tool with two sensors. The tool has an outer housing 10, an inner housing 20, and a fluid annulus therebetween for drilling fluid to circulate. In the illustrated embodiment, outer housing 10 and inner housing 20 are, substantially, concentric, elongate, and cylindrical. The inner housing may have a closed end, for example, on its distal end as illustrated in FIG. 1A. Inner housing 20 may have disposed therein a radioactive source 30 (or emitter) proximate its closed end, and gamma ray sensors, including a short spacing sensor 40, which may be axially above the radioactive source 30, and a long spacing sensor 50 axially above short spacing sensor 40. The source and sensors may be arranged differently in some embodiments.

Outer housing 10 may have windows 60, 70, 80 about each of the radioactive source 30, short spacing sensor 40, and long spacing sensor 50, respectively. The windows 60, 70, 80 may be made of a low-Z material to allow gamma rays to transmit therethrough. The windows may be slanted, that is, they may open downward and/or upward. In other words, the windows may be a gap in outer housing 10 that extends outward and at an angle from the long axis of the outer housing. In the illustrated embodiment, windows 70 and 80 open downward, and window 60 opens upward.

The tool may use its emitter to emit waves into a surrounding formation, and may use the sensor to detect waves that are reflected off of the formation. Such tools are used, for example, to measure density of a formation. Such tools may be used for other applications as well.

FIG. 1B illustrates a cross sectional view of a density tool with three sensors according to one embodiment of the present invention. This density tool is similar to that of FIG. 1A, with the additional element of a second long space sensor 90 disposed axially above long spacing sensor 50. Long spacing sensor 90 may be disposed in a section of housing that can shield it from gamma rays from the formation. Accordingly, unlike the other sensors, sensor 90 does not have a window disposed thereabout. Sensor 90 may be referred to as a shielded sensor. Any number of additional shielded sensors may be added or substituted, for example, for each of the types of noise that is to be compensated for.

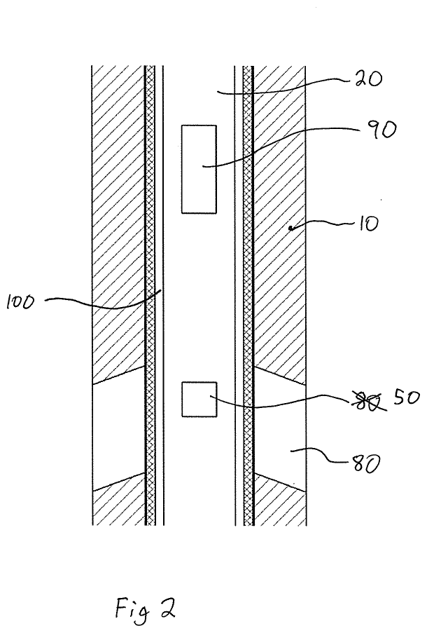

FIG. 2 is a partly cut-away, magnified view of the embodiment of FIG. 1B focused on the mid-space sensor 50 and second long space sensor 90. In the illustrated embodiment, gamma ray background noise may be increased due to the presence of a fluid annulus 100 between outer housing 10 and inner housing 20. External housing may be made of a high density and/or high atomic number material, such as steel, thereby increasing its shielding properties.

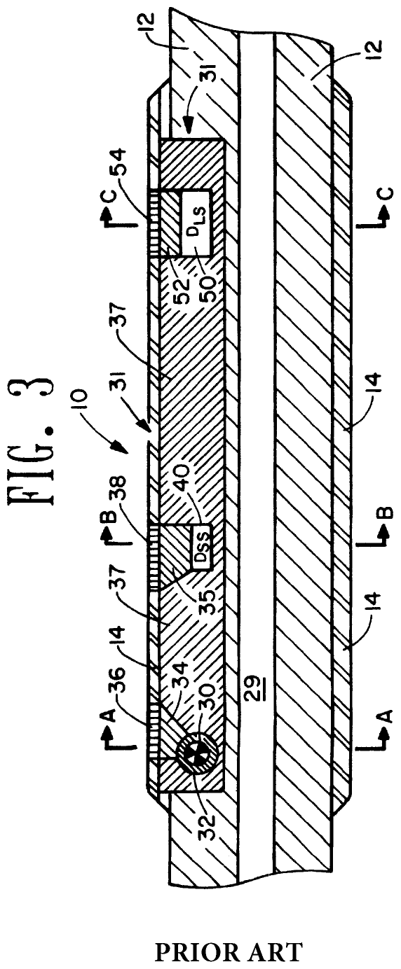

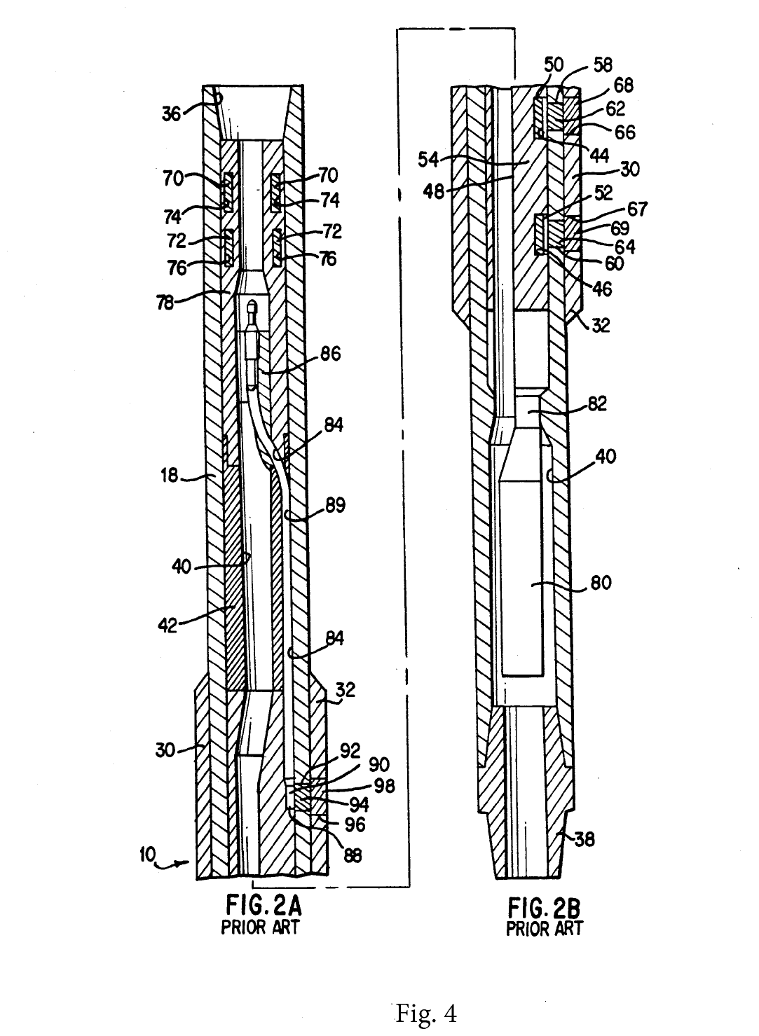

FIGS. 3 and 4 are prior art that illustrate examples of the internal fluid channels required for MWD/LWD density logging tools, which could be modified according to the methods and apparatus described herein to allow for measurement and compensation of background noise of these prior art apparatus.

In one embodiment, a long spacing sensor, such as long spacing sensor 90, is added to a pre-existing tool in an area where, in use, the sensor is shielded from gamma rays from the outside formation. The long spacing sensor may be used to measure noise within the outer housing of the tool.

A first, unshielded sensor may measure waves from the formation. The unshielded sensor may also detect waves within the tool (i.e., noise), which may give rise to inaccurate results. A second, shielded sensor may measure waves within the tool (i.e., the noise alone). The measurements of the first sensor may be adjusted based on the measurements from the second sensor such that the first sensor's results are compensated for noise. For example, the measurements of the second sensor may be subtracted from those of the first sensor.

One or more measurement devices (such as sensors) may be added to a tool to measure a variable background noise that is caused by an environmental effect from within the outer diameter of the tool. The sensors and/or tool may measure any one or more of density, porosity, and resistivity. The sensors and/or tool may be for measuring such attributes of a formation into which the tool is deployed. Each of the sensors of the tool may be used to measure the same and/or different attributes. Shielded sensors may be paired with unshielded sensors, and their measurements may be used to calculate a noise-compensated measurement.

One or more of the sensors of a tool may be shielded from radiation from the formation, such that the one or more sensors is tuned to detect radiation from within the tool, for example, between the inner housing and outer housing of the tool. The measurements of the tool may be adjusted to compensate for the radiation detected within the tool.

The tool and/or the sensors may, for example, measure any one or more of: gamma waves, sound waves, neutrons, and any number of other types of signals. The sensors may be KCl gamma sensors. The sensors may be for detecting prompt gammas from thermal neutrons.

Calculations, measurements, and/or corrections may be made with any one or more of: techniques for measurement while logging; the use of, or data from, physics, lab measurements, and modeling.

### CLAUSES

Clause 1. An apparatus for compensated formation evaluation, comprising: an outer housing; an inner housing disposed within the outer housing; an emitter disposed within the inner housing; a first sensor disposed within the inner housing; a first window in the outer housing, positioned about the emitter, to permit signals from the emitter to pass out of the outer housing; a second window in the outer housing, positioned about the first sensor, to permit signals to reach the first sensor from out of the outer housing; and a second sensor disposed within the inner housing.

Clause 2. A method for use of the apparatus of any one or more of claims 1-3, comprising: recording measurements from the first sensor and the second sensor; and adjusting a measurement of the first sensor using a second measurement of the second sensor.

Clause 3. A method for configuring an apparatus for formation evaluation to compensate for noise, comprising: positioning a sensor in an inner housing of the apparatus within a shielded portion of an outer housing of the apparatus.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. An apparatus for compensated formation evaluation, comprising:
an outer housing;
an inner housing disposed within the outer housing;
an emitter disposed within the inner housing;
a first sensor disposed within the inner housing;
a first window in the outer housing, positioned about the emitter, to permit signals from the emitter to pass out of the outer housing;
a second window in the outer housing, positioned about the first sensor, to permit signals to reach the first sensor from out of the outer housing; and
a second sensor disposed within the inner housing.

2. A method for use of the apparatus of claim 1, comprising:
recording measurements from the first sensor and the second sensor; and
adjusting a measurement of the first sensor using a second measurement of the second sensor.

3. A method for configuring an apparatus for formation evaluation to compensate for noise, comprising:
positioning a sensor in an inner housing of the apparatus within a shielded portion of an outer housing of the apparatus.
